(19) United States
(12) Patent Application Publication
(10) Pub. No.: US 2008/0201095 A1
(43) Pub. Date: Aug. 21, 2008

(54) Method for Calibrating an Analytical Instrument

(76) Inventors: Ping F. Yip, Winchester, MA (US); Brian C. Mansfield, Catonsville, MD (US); John M. Peltier, Jefferson, MD (US); Paolo Lecchi, Rockville, MD (US); Greg P. Bertenshaw, Gaithersburg, MD (US); Wesley S. Wiggins, Brambleton, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/030,039

(22) Filed: Feb. 12, 2008

Related U.S. Application Data
(60) Provisional application No. 60/900,729, filed on Feb. 12, 2007.
(60) Provisional application No. 60/960,995, filed on Oct. 24, 2007.

(51) Int. Cl. G01D 18/00

(52) U.S. Cl. 702/85

(57) ABSTRACT

Methods are provided for calibrating analytical instruments that comprise a quantitative device, such as spectrometers, particularly where a complex mixture is analyzed over a broad spectral range. Associated computer and analytical systems as well as software are also provided.

### CROSS-REFERENCE TO RELATED APPLICATIONS

This application claims priority to U.S. Patent Application Ser. No. 60/900,729, filed on Feb. 12, 2007 and entitled “A Method for Calibrating a Spectrometer,” and to U.S. Patent Application Ser. No. 60/960,995, filed on Oct. 24, 2007 and entitled “A Method for Calibrating a Spectrometer,” both of which are incorporated in their entirety herein by reference.

### FIELD OF THE INVENTION

This invention provides methods for calibrating or tuning analytical instruments that comprise a quantitative device, such as spectrometers and scanners, particularly where data derived from a complex mixture is analyzed, for example over a broad measurement range.

### BACKGROUND

It is a recognized problem in many fields of analysis that the intensity of a given signal reported by an instrument's detector might vary over time or vary from instrument to instrument as a function of various electronic, mechanical, physical and environmental factors. Relatively little attention has been devoted, for example, to the reproducibility of signal intensity across a broad spectral range. This is not surprising, because most conventional semi-quantitative or quantitative methods rely on measuring the relative intensity of one analyte of interest relative to a standard of known concentration that is co-analyzed or co-measured with the sample of interest. However, as clinical and industrial applications emerge for genomic, proteomic and metabolomic analyses in particular, it is critical that the accuracy and reproducibility of relevant analytical detection devices be improved, particularly to acceptable levels of clinical reproducibility.

In contrast, with respect to mass spectrometers by way of specific example, considerable effort has been applied to improving the mass accuracy and resolution of spectra, driven by an interest in being able to identify unambiguously, or at least reduce the number of unambiguous possible identities, of an analyte forming a peak at a given m/z value. This is useful when positive identification of various chemical compounds is needed, such as when monitoring drug levels in blood serum.

Techniques are generally known to enhance the reproducible, quantitative analysis of single species such as therapeutic drugs. Whereas, quantitative reproducibility across a spectral range remains a problem in the absence of viable techniques for co-analyzing or co-measuring known concentrations of standard compounds along with a sample to be analyzed. For example, in the field of proteomics, a spectrum derived from blood serum is associated with up to tens of thousands of molecular species and is typically generated and analyzed using, for example, mass spectrometry or NMR. With mass spectrometry, while multiple different standards may be analyzed in a sample, and used to estimate the individual amounts of multiple different analytes, these are interpreted for individual analytes, essentially the same way as doing multiple analyses, one for each analyte of interest. There is little known, for example, in the field of mass spectrometry about how to maintain consistent ratios reflecting the relative concentrations of multiple analytes at widely different m/z values. And for diagnostic and other analyses aimed at finding patterns of components within a complex mixture or matrix, achieving and maintaining a reproducible relative intensity is a fundamental objective.

Various approaches to calibrating an instrument overall, by adjusting its various settings and/or computationally compensating for instrument variability are known but generally do not address the variability in quantification by the instrument. For example, most manufacturers of mass spectrometer devices utilize a calibration algorithm of one sort or another that takes into account parameters such as, for example, thermal expansion and efficiency of ion transport to adjust the device's output automatically. Such adjustments generally are intended to address mass accuracy. For example, standard or reference compounds are selected to have an m/z value unlike any in a biological molecule. The calibration program looks for the m/z signature of those compounds, determines whether the m/z signature is present above an intensity set by the operator and close to the compounds' expected m/z values, and then adjusts the x-axis output to give an exact mass alignment. There are numerous examples of calibration mixtures.

Concerns about insufficient within-day reproducibility of laboratory instruments such as LC-MS spectrometers have been reported. See, for example, Gika et al., “Within-Day Reproducibility of an HPLC-MS-Based Method for Metabonomic Analysis: Application to Human Urine,” J. Proteome Res. 6 (8), 3291-3303, 2007. However, limited examples of adjustments with regard to adjusting signal intensity of mass spectrometers have been published, particularly for applications such as pattern recognition of complex mixtures of compounds. See, for example, Steiner, U.S. Pat. No. 7,047,144 (2006), entitled “Ion Detection in Mass Spectrometry With Extended Dynamic Range.” However, Steiner seeks to bring the signal into a more efficient detection range rather than adjusting spectrometer settings to compensate for machine “drift” or other factors that compromise reproducibility across a wide spectral range. Thus, this reference describes a method for optimizing an ion detector control voltage, such as in a mass spectrometer, the largest peak in the array of mass scan data is evaluated to determine whether the current detector gain should be changed with a different setting of the control voltage. Alternatively, a control voltage may be modified to prevent the number of ions reaching the ion detector from exceeding the linear detection range of that detector. Implementations of this process have variously been referred to as automatic gain control or dynamic fill time control. See, also, Gusev et al., “Improvement of Signal Reproducibility and Matrix/Comatrix Effects in MALDI Analysis,” Anal. Chem. 67:1034-1041 (1995) which notes the problem. See also Semmes et al., “Evaluation of Serum Protein Profiling by Surface-Enhanced Laser Desorption/Ionization Time-of-Flight Mass Spectrometry for the Detection of Prostate Cancer: I. Assessment of Platform Reproducibility,” Clinical Chemistry 51(1):102-112 (2005), and Hidalgo et al., “The Application of High Speed Oscilloscope Analog-to-Digital Converters to Time-of-Flight Mass Spectrometry,” ASMS 2007, MPE 076 (2007).

In some embodiments, the present invention utilizes a comparison of centroids in n-dimensional space for quality control purposes. The use of centroiding for other quality control purposes, however, has been described. See, for example, Hitt et al., Published U.S. Patent Application 2004/0058372 (2004), entitled “Quality assurance for high-throughput bioassay methods;” Hitt et al., Published U.S. Patent Application 2004/0053333 (2004), entitled “Quality assurance/quality control for electrospray ionization processes;” and Chen, et al., PCT Application PCT/US04/041135, entitled “Method of Diagnosing Biological States Through the Use of a Centralized, Adaptive Model, and Remote Sample Processing.” While the underlying approach to generating and evaluating centroids (referred to as centroiding) and their relative positions in Euclidean space as disclosed in these references is appropriate to employ for the methods described and claimed in this patent application, the purposes and methods of the present invention are distinct.

The same issue with machine-to-machine variability as described above for mass spectrometry is routinely recognized for other types of instruments that utilize detectors for quantitative analysis (either absolute or relative), such instruments containing, for example, CCDs, MCPs, CMOS chips, coulombmetric detectors, photomultipliers and the like. For example, the “Microarray Scanner Calibration Slide User's Guide” by Full Moon BioSystems (Part No. DS 01) (“Guide”) supports a gene array scanner that detects and quantifies a fluorometric signal. In this regard, the Guide notes an issue about how to detect and analyze performance variations among different microarray scanner units. Yet the guidance provided to address this problem is limited and involves comparing two sets of images and data obtained from the use of two units.

What is needed in the art is a method and associated computer systems and software tools to evaluate and enhance the reproducibility of instruments that measure the quantities, particularly the relative quantities, of the components of a sample, particularly across a broad measurement range and particularly for complex samples. For the purposes of this invention, reproducibility of instruments refers to reproducibility on a single instrument over time, as well as, reproducibility between instruments of the same type. Reproducibility means that one or more instruments are sufficiently or acceptably reproducible for an intended purpose, such as the clinical or diagnostic analysis of patient's blood (or other fluid or tissue samples).

### SUMMARY OF THE INVENTION

The present invention relates to methods for calibrating an instrument such as a spectrometer, comprising the steps of providing the location in n-dimensional space of a reference centroid derived from the quantity of one or more compounds in a reference sample (whether or not processed by the instrument); providing the location in n-dimensional space of a test centroid derived from the quantity of one or more compounds in a test sample processed by the instrument; computing a vector that reflects the distance between the reference centroid and test centroid, for example by using Euclidean distance; determining the extent to which an adjustment to one or more equipment settings would either decrease the distance between and/or improve the relative locations of the centroids or their acceptable decision boundaries (that is, if the distance is not Euclidean one may move further from the centroid yet be closer to the boundary as with an ellipsoid boundary); and effecting adjustments to the equipment settings to calibrate the instrument. To facilitate the process of adjusting the instrument settings to minimize the distance between the reference and test centroid, alternative two-dimensional representations of the centroids vs. the instrument tuning parameters might also be used; for example, one or more, normalized ratios of specific spectral peaks.

In a preferred embodiment, the instrument is a spectrometer, particularly a mass spectrometer. In another preferred embodiment, the instrument is an array scanner, particularly a nucleotide microarray scanner.

The present invention provides methods to calibrate an instrument in ways that enhance the reproducibility of the quantitative evaluation of samples performed by the instrument. Also contemplated are methods, software products, digital computers and analytical instruments in which the step of effecting adjustments is automated for the instrument, and, optionally, the user is provided with a report as to the types and extent of such adjustments. The present invention also provides methods, software products, processors, digital computers and instruments that provide to the instrument's operator recommendations or suggestions for appropriate adjustments to be effected on the instrument.

In addition, the methods of the present invention may be used to evaluate the intrinsic similarities or intrinsic differences between instruments. For example, variances that result from acceptable manufacturing tolerances may produce instruments that are sufficiently different in their performance characteristics that re-tuning will not be adequate. Consequently, generating centroids, peak ratios or other data to examine the initial similarity of manufactured instruments provides a way to identify a subset of instruments that is most ideally suited to deployment in settings where reproducibility is highly desirable, such as clinical laboratories.

In one embodiment, multiple parameters can be adjusted to tune an instrument. Such an embodiment can include, for example, adjusting the instrument to baseline conditions, establishing reference profiles of compounds using the instrument, defining a reference response of the instrument, defining error tolerances, comparing a test response to the reference response, and minimizing differences by determining an adjustment or multiple adjustments to the parameters based on the reference profiles, reference response, test response and/or test profiles.

### THE DRAWING FIGURES

The foregoing summary, as well as the following detailed description of the invention, will be better understood when read in conjunction with the appended drawings. For the purpose of illustrating the invention, the embodiment(s) shown in the following drawings are presently preferred. It should be understood, however, that the invention is not limited to the precise arrangements and embodiments shown.

FIG. 1 illustrates the variance in the height (ion intensity) of various compound peaks at the indicated m/z values depending on the needle position.

FIG. 2. illustrates the variance of various compound peaks heights at the indicated voltage settings of the Peaks (RF Guide) Voltage.

FIG. 3. illustrates the variance of various compound peak heights at the indicated voltage settings of the Orifice 1 Voltage.

FIG. 4. illustrates the variability in the Euclidean distance between reference and test centroids computed for the sample mixture at various Orifice 1 Voltage settings.

FIG. 5. illustrates the effect of adjusting the Orifice 1 Voltage settings as reflected by the relative ratios of two m/z features on two different mass spectrometers.

FIG. 6 is a reference profile of an analyte for an instrument, according to an embodiment of the invention.

FIG. 7 is a reference centroid including an error tolerance, according to an embodiment of the invention.

FIG. 8 illustrates test responses and a reference response, according to an embodiment of the invention.

FIG. 9 illustrates a vector space that includes a reference response according to an embodiment of the invention.

FIG. 10 illustrates a reference profile and a test profile including error tolerances, according to an embodiment of the invention.

FIG. 11 is a schematic diagram of a mass spectrometer including adjustable parameters, according to an embodiment of the invention.

FIG. 12 is a schematic diagram of a mass spectrometer including adjustable parameters, according to an embodiment of the invention.

FIG. 13 illustrates the response of a mass spectrometer to a thermometer ion during variation of adjustable parameters of the mass spectrometer, according to an embodiment of the invention.

FIG. 14 illustrates the response of a mass spectrometer to a thermometer ion during variation of adjustable parameters of the mass spectrometer, according to an embodiment of the invention.

FIG. 15 is table of values for adjusting reference parameters of a mass spectrometer, according to an embodiment of the invention.

FIG. 16 illustrates a reference profile of an analyte for a mass spectrometer, according to an embodiment of the invention.

FIG. 17 is a flowchart illustrating a method for tuning an instrument, according to an embodiment of the invention.

### DETAILED DESCRIPTION

It is contemplated that various devices and types of analytical instrumentation that make quantitative analysis of components of samples are appropriate for the claimed methods, such as mass spectrometers, infrared spectrometers, Raman spectrometers, nucleotide array detectors, optical spectrometers, digital cameras, and analytical instruments for surface or conformational analysis, X-ray photoelectron spectroscopy (XPS), X-ray photoelectron diffraction (XPED), and Vibrational circular dichroism (VCD). In general, any instrument is contemplated as being relevant for the present invention if such instrument is utilized to generate data, for example spectra, for which it is important to maintain a reproducible response in order to compare different sample profiles. Persons skilled in the use of such instrumentation will readily be able to apply the methods described herein to such devices.

Although the examples that follow generally relate to analysis using mass spectrometers, it is contemplated that the methods of the present invention are applicable to various other clinical instruments such as antibody arrays including sandwich microarrays that perform multiplex detection and analysis of proteins such as the instruments marketed by Pierce. Also contemplated are the use of tissue microarrays that provide high-throughput detection of gene expression and protein expression in a variety of tissues, for example the tissue microarrays produced by Full Moon BioSystems. These are tissues provided on a positively charged microscope slides that are fixed under a thin layer of paraffin. Similarly, the methods of the present invention are applicable to microarray scanners by Full Moon BioSystems and to PerkinElmer's ScanArray® instruments which combine confocal technology with laser for analysis of a wide variety of genomic and proteomic analytes. Based on the following discussion, persons skilled in the art would select appropriate reference compounds capable of being detected by and evaluated in the context of the reference profiles described below by whatever instrument is being calibrated.

In a preferred embodiment, the present invention relates to a method of calibrating a mass spectrometer to enhance the reproducibility of the data, including spectra, that it produces. For purposes of the present invention, familiarity with the various control settings of a mass spectrometer is assumed, as is the case for persons skilled in the field of spectrometry. In general, a mass spectrometer comprises five main components: a sample inlet system to introduce a sample into the spectrometer, an ion source which forms gaseous charged analyte ions of the sample, an ion optics system which guides the ionized sample into the spectrometer, a separator step which separates analyte ions based on their mass-to-charge ratios (“m/z ratios”), and a detector which converts the beam of ions into an electrical signal that can be processed, analyzed and stored. Also, for purposes of the present invention, the term “reproducible” does not necessarily mean “identical.” Thus, this term is intended to mean that the analysis of the same analyte on multiple occasions provides results that are substantially the same. Minimally, the results would allow the analysis and subsequent classification of a biological sample to yield the same clinical or biological result as prior analysis on the same instrument or a different instrument. The disclosed approach can be applied to diverse types of mass spectrometers that employ diverse methods of producing ions for analysis, including MALDI, SELDI, DESI and DART instruments.

Numerous adjustments are known that can be made to a mass spectrometer to tune the accuracy of its mass determination. In contrast, the methods of the present invention generally relate to enhancing reproducibility of the spectra along the “y-axis” component of a spectral analysis, which reflects the intensity (or quantity) of a detected molecular species, which for mass spectrometry would be correlated to a given m/z value. By way of clarification, the present invention is not primarily directed to the “x-axis” component of a mass spectral analysis, which captures the mass accuracy of the mass-to-charge ratio or “resolution” of a spectrum. And for purposes of the present invention, it is presumed that any deviations in mass accuracy (y-axis) are first corrected by known calibration techniques prior to applying the approach described in this application for evaluating and adjusting sensitivity (y-axis), although in some embodiments of the present invention the x-axis and y-axis calibrations may occur in parallel.

The following discussion and examples relate specifically to an electrospray (ESI) time of flight (TOF) spectrometer. However, a person skilled in the art will recognize that other types of mass spectrometers, and other types of spectrometers more generally, will have comparable adjustments. An exemplary instrument is the JEOL model JMS-T100LC (“AccuTOF”) spectrometer, and the instruction manual for this TOF (MST100LC-20 (5611), FEB2003-10210068) is incorporated by reference in its entirety. Most of the relevant tuning settings and adjustments can be made to the AccuTOF by accessing the MS Tune Manager interface. Mass spectrometers produced by other manufacturers have comparable tuning interfaces and comparable or additional settings that may be adjusted by a user.

With respect to the AccuTOF, and using the terminology presented in the instrument's instruction manual, the Tune Manager provides access to settings for the Ion Source, specifically, the Needle Voltage, the Ring Lens Voltage, the Orifice 1 Voltage, the Peaks Voltage and the Orifice 2 Voltage. Similarly, the Tune Manager provides access to settings for the Analyzer, specifically, the High Frequency Sweep, the Bias Voltage and the Pusher Bias Voltage. Access to settings for the Detector (which a person skilled in the art will understand as referring to the mass separator or mass analyzer) also are provided, specifically the Pusher Voltage, Pulling Voltage, Suppress Voltage and Flight Tube Voltage. The MS Tune Manager also provides access to settings for Temperature/Gas for the user-selected ion source, specifically the: Desolvating Chamber and Orifice 1.

Another exemplary TOF is the Agilent 6210 TOF LC/MS, which similarly provides access to various settings through the Tune Pane in the Data Acquisition window. By way of example, settings are identified for ion polarity (i.e., positive or negative), Ion Source, Gas Temp, Drying Gas flow rate, Nebulizer pressure, as well as voltage settings for the Ion Source, Beam Shaping, Transfer Optics and TOF Analyzer and Detector. See, for example, the Quick Start Guide for the Agilent 6210 TOF LC/MS (Manual Part No. G3335-90010, January 2007). However, any measurable (tunable) parameters that affect the peak intensity can be considered for this application. However, this specification focuses on voltage parameters of the ion source (that is, the region of the instrument that is most likely to observe drifting of instrument performance during the time course of an analysis).

According to the present invention, it is also contemplated that physical adjustments can be made to a mass spectrometer with similar effects as the electronic tuning adjustments listed above if such components and adjustments affect the quantitation of signal reported by the instrument's detector. These may include, by way of example, cleaning the electrospray chamber, replacing the nebulizer needle, cleaning the APCI spray chamber, cleaning or replacing the corona needle, cleaning or replacing the capillary, replacing the LC filter elements and the like. Such physical adjustments are described, for example, in the Maintenance Guide for the Agilent 6210 TOF LC/MS (Manual Part No. G2581-90005, October 2006). Analogous physical adjustments can be made to the AccuTOF and comparable TOFs and analogous mass spectrometers. Persons skilled in the art will recognize that some adjustments and control parameters will be relevant to various modes of operation and not others. For example, the APCI (atmospheric pressure chemical ionization) spray chamber would not be relevant to ESI mode. Contemplated types of mass spectrometer ionization modes include AP-MALDI, ESI, APCI, DART and DESI instrumentation.

It is also contemplated that other operational parameters can be adjusted with a determinable impact on reproducibility. These would include the nitrogen flow rate, sample and solvent flow rate, solvent composition and injection volume. See, for example, the Familiarization Guide for the Agilent 6210 TOF LC/MS (Manual Part No. G3335-90013, January 2007). Similarly, adjustments can be made to the environment in which a mass spectrometer is operated, such as controlling more precisely or adjusting ambient temperature.

### A. Selecting Standards and Determining a Reference Centroid

In some embodiments, a reference centroid is computed and provided for later comparative purposes, which is the location in n-dimensional space of a reference point associated with one or more reference samples. In one embodiment, the centroid reflects the relative ratios of the intensity of peaks at particular m/z values that are associated with the molecular species in the sample. In some embodiments, the peak intensities will be normalized in such a manner as to provide well-defined boundaries to the n-dimensional space. In other embodiments, the instrument's data may be scaled or subjected to various types of pre-processing prior to normalization or other analysis. In one such normalization, the intensity of one species, the most intense, will be assigned an arbitrary value of 1.0 and all other species intensities scaled accordingly by dividing their intensity by that of the maximum intensity. Other types of normalization are contemplated, for example, the 0 to 1 approach or unit sphere approach. By way of example, if a centroid were determined for eight compounds in a reference sample, the centroid would be located in 8-dimensional space. The process of creating such a centroid can be referred to as centroiding.

The location of this reference centroid is then compared with the location in n-dimensional space of one or more or test centroids associate with test samples in order to determine appropriate calibration adjustments that might be made to the instrument or device being calibrated. The practical goal is to calibrate the applicable device such that an appropriate measure of distance (for example, the geometric distance) between these centroids in multidimensional space is decreased. A person skilled in the art will recognize that there may be confounding effects from any particular adjustment, such as an increase in fragmentation of molecules in a sample if, for example, certain ion source voltages are increased. Similarly, the effect of a given adjustment might vary for molecules having lower as opposed to higher m/z values. Thus, one or more adjustments would be made in a coordinated way to decrease the centroid-to-centroid distance while introducing minimal confounding effects. The effect of such adjustments would typically be assessed empirically.

In general, the techniques described in this application are of a tuning or fine-tuning nature. If the instrument to be calibrated or tuned is grossly out of alignment or its data output deviates substantially from expected values, then conventional alignment, cleaning and calibration steps would be indicated as needed first.

Preferably, one or more analytes, for example a single analyte or a set of chemical components, are utilized as reference or calibration standards to derive the reference centroid. Such standards may be evaluated alone or may be spiked into whatever test sample will be utilized. For mass spectrometry, a reference sample set preferably will have “n” components of interest, generally at least about three to five components, and more preferably about five to ten components. Alternatively, if a single analyte is used, it may be induced to fragment to yield one or more additional components; ideally one to five additional components dispersed along a desirable m/z range. More components can be used as might be determined to be useful for the instrument and type of analysis to be conducted. Such compound standards also may be spiked into a sample of the type to be analyzed, such as serum extracts, at predetermined and known relative concentrations. If such an approach is undertaken, the standards preferably will not already be present in the sample to be analyzed. However, the standards can also be the same as endogenous components of a sample to be analyzed so long as the intensity of their signal is not altered or compromised by the endogenous components natively present.

Preferably, compounds are selected that are stable and efficiently analyzed; that is to say that they give specific and identifiable peaks. The exact nature and mix of components is within the level of skill of practitioners. See, for example, Tang et al., “Expediting the Method Development and Quality Control of Reversed-Phase Liquid Chromatography Electrospray Ionization Mass Spectrometry for Pharmaceutical Analysis by Using an LC/MS Performance Test Mix,” Anal. Chem. 72:5211-5218 (2000), and Li et al., “Enhanced Performance Test Mix for High-Throughput LC/MS Analysis of Pharmaceutical Compounds,” J. Comb. Chem. 8:820-828 (2006).

JEOL suggests the use, as reference calibration standards for purposes of mass accuracy, of cesium iodide, trifluoro acetic acid, polyethyleneglycol and polypropyleneglycol. Agilent uses a mixture of phospazines and, previously, perfluorokerosene. ThermoFinnigan uses a mixture called Ultramark. All these reference standards generate multiple species with predictable or calculable increments in molecular weight that cover a wide m/z range. The mass accuracy (x-axis) of the mass spectrometer instrument is calibrated by aligning the m/z detected experimentally of the mixture with the respective expected m/z (calculated). When the relative intensities of the components of a mixture are known, such compounds also may be used in the methods of the present invention.

It has been found that the use of certain single analytes that become fragmented into ions with known or readily determined intrinsic charges and masses are helpful to provide an indication of intrinsic instrument performance. Such analytes are referred to as “thermometer ions” in this specification. Because the computational methods of the present invention utilize ratios of the fragments to the precursor from which they are derived, the measurements have a low sensitivity to small changes in the concentration of the test compound. As will be appreciated, such variances in the concentration may occur from the preparation of multiple batches of test compound solution. Similarly, the results are relatively insensitive, for example, to small changes in the amount of sample injected by the autosampler typically used with the MS system.

An appropriate thermometer ion gives an accurate indication of instrument performance characteristics down-stream of the region in which ionization and desorption normally occur. Although thermometer ions generally have been described in the literature, their use is reported for the purpose of monitoring internal distribution of energy deposited into the ions produced by ESI or variants thereof and monitoring the first stage of the atmosphere-vacuum interface. See, for example, Smith et al., “Internal Energy Distribution of the Ions Produced in DESI and ESSI and the Influence of Source Parameters on Internal Energy,” ASMS Poster WP035 (2007); Gabelica et al., “Internal Energy and Fragmentation of Ions Produced in Electrospray Sources,” Mass Spectrometry Reviews 24:566-587 (2005); and Collette et al., “Calibration of the Internal Energy Distribution of Ions Produced by Electrospray,” Rapid Communications in Mass Spectrometry, 12:165-170 (1998).

Thermometer ions are also sensitive and useful probes for energy related effects further into the interface of a mass spectrometer, where the pressure is lower and collision-induced fragmentation processes are less well described than for the higher pressure regions. It has been discovered that the peak ratios also are modified by transmission related effects that are independent of the internal energy and associated fragmentation of the ions. Moreover, thermometer ions appropriately may be used to readily indicate when an LC/MS system is not yet at equilibrium, as is often the case for the first few analyses performed on a given instrument each day or during a defined experimental period after a period of non-use or after instrument settings have been changed. In principal, other classes of molecules or combinations of molecules could be used to monitor these effects, but the thermometer ions are convenient and preferred because they are sensitive to the equilibration state and are also used for probing other aspects of the performance. For example, using the chlorinated thermometer ion 4-chlorobenzyl pyridinium chloride, saturation effects for strong signals has been monitored.

In other studies, thermometer ions have been used to evaluate a change in peak ratios that is caused be the software controlled baseline offset. It has an impact on peak ratios when one of the pair of peaks is of low abundance and is important to control since analyte profiles may involve one or more low abundance peaks. Persons skilled in the art will also recognize that pairs of thermometer ions may be used simultaneously to generate a two-dimensional plot that could allow better instrument tuning for reproducibility than using a single thermometer ion peak pair alone. Because it yields a simple two-dimensional plot, pairs of ions could readily be used to optimize tuning manually or with an automated computer algorithm.

Appropriate thermometer ions as contemplated for the methods of the present invention include compounds that ideally are confirmed empirically to undergo large changes in fragmentation in a small range of instrument settings at or near the optimal settings for the analysis of biological samples, for example plasma or serum. Exemplary thermometer ions for the AccuTOF are 4-methoxybenzyl pyridinium chloride and 4-chlorobenzyl pyridinium chloride. Ideally, one or more thermometer ions also will produce predictable fragments in a molecular weight range comparable to the molecular species of the samples to be analyzed. It is contemplated, for example, that angiotensin and bradykinin also can be utilized as thermometer molecules for purposes of the present invention.

Other molecules in addition to the foregoing specific suggestions may be used as appropriate. Such molecules will have an intrinsic charge or will be easily induced to acquire a charge so that the ionization process does not confound the evaluation of instrument characteristics. Similarly, the molecules will be readily desorbed into the gas phase to minimize confounding effects. The molecules will be chemically and physically stable yet be readily fragmented in the mass spectrometer in a predictable way. The number of fragments produced will ideally be in the range of about 1-5 and of a relative abundance that allows their relative ratios to be accurately and reproducibly determined. The fragmentation of the molecules and transmission of the fragments will be very sensitive to changes in the instrument voltage settings so that fine tuning adjustments will be possible. Conversely, the ratios of abundance of the fragments and the precursor ion from which they are derived will be relatively insensitive to the concentration of the test solution used to introduce them into the mass spectrometer, so that small variations in sample preparation do not confound the analysis.

The thermometer ions or other reference molecules or mixtures may be spiked into a subset of the biological samples to be analyzed, for example, pooled sets of sera that may be used as a standard, in order to assess the influence of a biological matrix on the overall results. Generally, they will not be spiked into all test samples to avoid influencing the ratios of signals in those samples.

Generally, the y-axis intensity (quantification) signal should meet some minimum intensity and avoid saturation before being centroided as would be known to persons skilled in the art. Thus, for example, as part of an overall quality control process, signals that are low relative to background or noise signals would preferably not be utilized. Similarly, signals that are very large might also be excluded if they exceed the linear detection range, because their amplitude will be underrepresented in the spectrum. Skilled artisans would be aware of the concentration of a given reference molecule and also how its spectrum should appear in general if the mass spectrometer is working properly. Generally, the peaks of the spectrum selected for centroiding should meet acceptable levels of intensity and quality.

As described in the Examples that follow and the Drawings, the following chemical, peptide and thermometer ion standards were used with the corresponding m/z values of their charged species as detected are as shown in Table 1, and where the short names in parentheses are as used in the Drawings and related discussion in the specification.

TABLE 1

| m/z | Common Chemical Name |
|---|---|
| 200.106 | (precursor) 4-methoxybenzyl pyridinium chloride (p-OMe) |
| | and its 121.064 fragment |
| 204.123 | (ALC) Acetyl Carnitine |
| 204.057 | (precursor) (fragment) 4-chlorobenzyl pyridinium chloride |
| | (p-Cl) and its 125.015 fragment |
| 233.128 | (TRE) Tryptophan Ethyl Ester |
| 289.216 | (TES) Testosterone |
| 361.266 | (COR) Cortisone |
| 496.344 | (LPL) Lysophosphatidyl choline (16:0-Lyso PC) |
| 518.321 | (LPL-Na) Lysophosphatidyl choline-Na+ |
| 524.272 | P5 sequence (YALSA) |
| 609.281 | (RES) Reserpine |
| 752.419 | P7 sequence (YALTLTA) |
| 758.569 | (PCL) Phosphatidylcoline (16:0-18:2 PC) |
| 780.551 | (PCL-Na) Phosphatidylcoline-Na+ |
| 907.550 | P8 sequence (LYLTLTLA) |

Variations and substitutions readily can be made. For example, a fluorinated derivative of phosphatidylcholine can be used, as can a variant of lysophosphatidylcholine having an odd number of carbon atoms. Alprazolam (a synthetic drug) also can be used.

The location of the reference centroids computed for the reference samples according to the present invention may be determined computationally by various known techniques, including those disclosed, for example, in Hitt et al., Published U.S. Patent Application 2004/0058372 (2004) and Hitt et al., Published U.S. Patent Application 2004/0053333 (2004), both of which are incorporated in their entirety herein by reference. These references describe the process of selecting features in a spectrum (here being m/z peaks associated with one or more of the molecular species in the reference sample), and calculating distances between centroids, etc.

A centroid may be derived from a single analysis or multiple analyses of reference samples. Generally, it is preferred that a given sample intended to provide a reference centroid, for example in a mass spectrometer, be analyzed a sufficient number of times such that the standard deviation from the mean of the location of the centroid computed for all analyses is satisfactory from a statistical perspective. For example, once a centroid is computed, a skilled artisan could apply a decision boundary to assure that various replicate centroids cluster appropriately, that is to determine standard deviation and exclude centroids when the results of an excess number of individual analyses fall outside the chosen decision boundary or potentially repeat sample analyses until a more uniform data set is acquired.

A preferred embodiment of the present invention would involve, for example, about 40-50 analyses of the same sample, preferably about 100 and more preferably about 200 analyses. Also, preferably, the calibration standards are selected such that the individual components don't change in relative abundance during repeat assays. It is important that repeat assays that generate data for the reference centroid are completed in a time frame that avoids change in the relative abundance of the n components as may be the case, for example, for serum samples stored in a conventional 96 well plate. Such a reference centroid typically would be generated on the same spectrometer, but also may be generated on another spectrometer of the same commercial model or, more generally, of a similar analytical type (i.e., TOFs or triple quadrupole mass spectrometers). In alternative embodiments, the location of the reference centroid also could be a computationally or theoretically determined point in n-dimensional space, or can be based on a single sample analysis rather than on repeated analyses.

### B. Evaluating Test Samples and Determining a Test Centroid

The same reference standards (or a set of reference standards that are substantially the same for the purposes of the present invention) are assayed again when the device is to be calibrated. For example, a solution of the standards may be prepared according to a prescribed formula. Alternatively, a solution containing the standards used to derive the original reference centroid may be prepared and then stably stored and reanalyzed, for example, on a mass spectrometer to be calibrated. A person skilled in the art will know what storage conditions are appropriate for a given type of reference sample. This could include, as the case may be for serum, freezing, drying down for later resuspending or otherwise stabilizing, for example, refrigerating or solubilizing in DMSO. The reference standards also could be provided in different matrices such as a buffered solution or serum.

Once the sample is reanalyzed, a test centroid is determined in an analogous manner to the reference centroid.

### C. Computing a Vector (or Distance) Between the Reference and Test Centroids

Any n-dimensional mapping program used routinely by persons skilled in the art would be appropriate for the methods of the present invention. For exemplary approaches, see Hitt et al., Published U.S. Patent Application 2004/0058372 (2004) and Hitt et al., Published U.S. Patent Application 2004/0053333 (2004). These references describe various techniques, including Euclidean, Hamming and Mahalanobis distance calculations. Alternatively, ratios of peak intensities or of peak intensity ratios may be computed and evaluated rather than centroids.

### D. Determining Appropriate Adiustments to Equipment Variables

A person skilled in the art will be able to identify and empirically assess potentially relevant equipment settings and make corresponding adjustments that influence the intensity or signal strength component of the instrument's output signal. Such equipment variables include electronic, mechanical, physical (for example, gas flow rates or carrier fluid rates in a mass spectrometer) and environmental settings as described above that might influence the location of the centroid in n-dimensional space. It is contemplated that any other settings or adjustments that affect the movement of a charged ion on its way through a mass spectrometer may be similarly relevant and appropriate for adjustment.

Various alternatives exist for evaluating reproducibility of an instrument's sensitivity. For example, it is conceivable that for some applications of the present invention, it would be appropriate to evaluate and adjust the settings of a mass spectrometer after every sample analysis, based, for example, on the pattern of standards spiked in the sample (such as blood serum or plasma). A dynamic or real-time analysis would be utilized where, as the sample is being analyzed (for example using standards spiked in a serum sample), the mass spectrometer adjusts through a feedback loop to correct relevant settings and keep the centroid “in tune”. This might mean that the first part of any analysis is a check and adjustment of the calibration, followed by a data acquisition for analysis once the centroid is determined to be within an acceptable limit. For most purposes, however, it would more likely be appropriate to monitor, evaluate and adjust occasionally, for example, each day or every 4 hours, or when the centroids drift too far apart and the accuracy of a test or analysis decreases. This schedule can be determined empirically for any given instrument or instrument model.

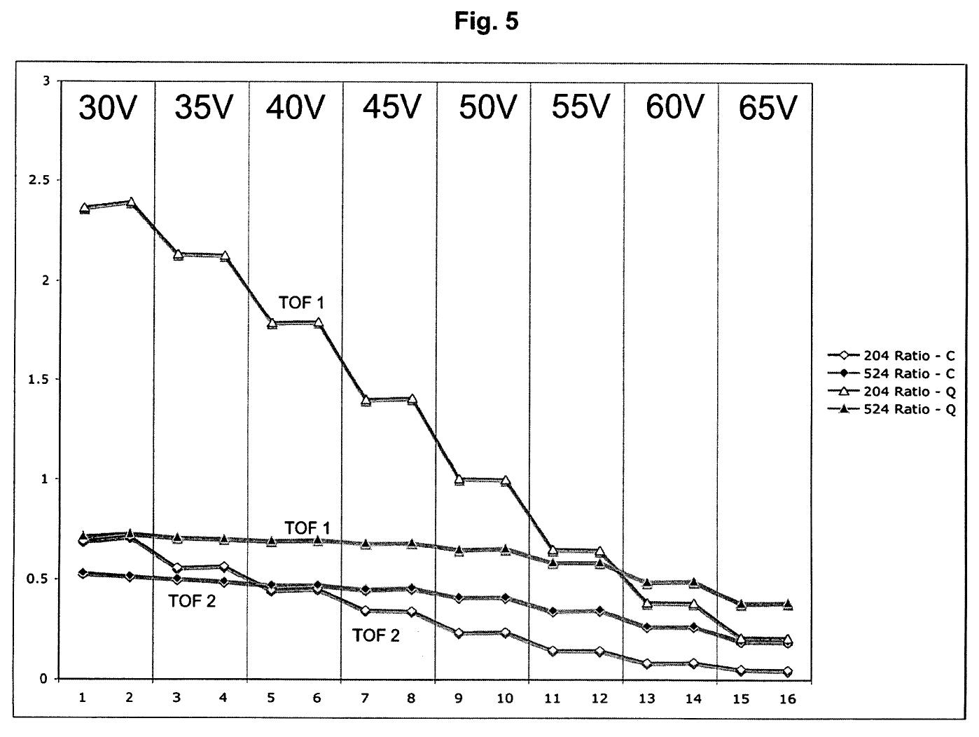

A limited number of “major adjustments” are contemplated as being generally relevant and persons skilled in the art will readily understand from the following discussion how to identify corresponding functions in instruments from other manufacturers. For example, on the AccuTOF, such a major adjustment would be the Orifice 1 Voltage adjustment exemplified below. For each of the identified adjustments and settings, a calibration curve readily can be generated empirically, for example, by holding all other settings and adjustments constant, but varying that one adjustment and building an adjustment or reference profile. For example, the instrument operator can run 10 analyses of the reference sample at voltages that increase serially by a set amount to determine how significant the variable is to the changing location of the test centroid. Ideally, one would step up the voltage and then step it back down to show that centroid moves away and then returns to its original position. See, for example, FIG. 5.

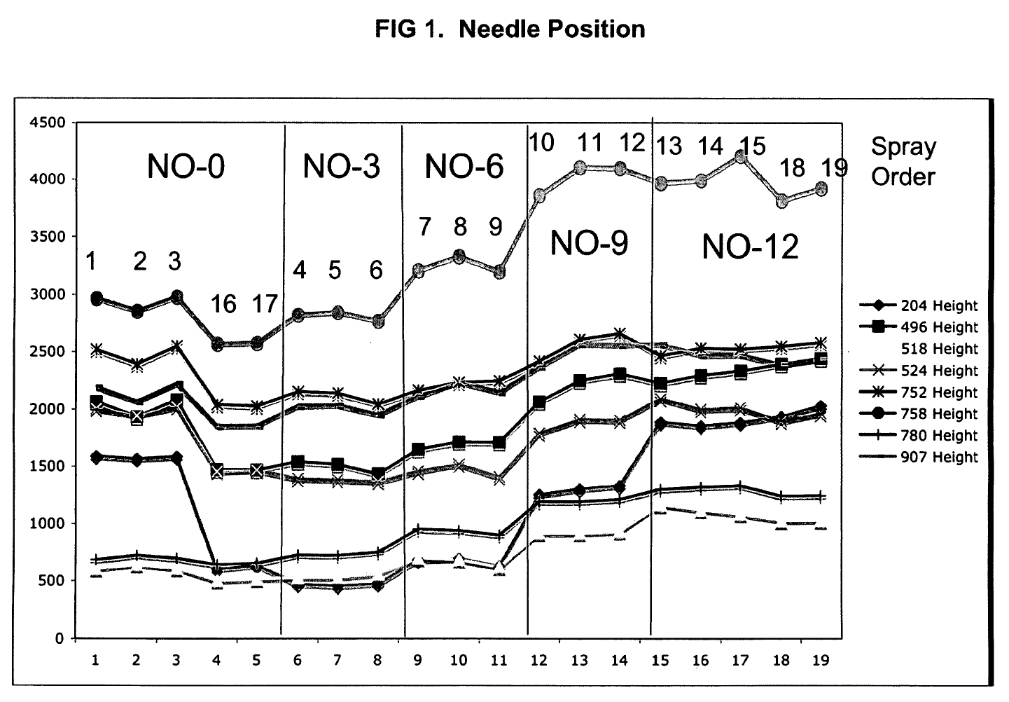

As a guide to assessing the significance of adjusting any particular parameter, one can also look at the relative ratios of peaks that constitute the features used to compute a reference centroid. See, for example, the needle height variability shown in FIG. 1. In this regard, the ratio between the m/z 758 peak and the m/z 518 peak remains relatively consistent even though the needle height is varied from one end of the adjustment range to the other. Thus, this adjustment may not be of primary value in decreasing the distance between the reference and test centroids. It should be kept in mind that the present invention is intended to reflect a fine-tuning of the instrument. Also, some ions will be relatively more sensitive to needle height than others.

### E. Adjusting/Calibrating the Spectrometer

Once the test centroid is computed and compared with the reference centroid, then the device can be adjusted by altering the various settings to decrease the distance between the reference and test centroids. Preferably, an algorithmic approach is developed to simplify the process of adjusting the setting and to automate it. Such an approach would involve the computation of expected effects of making adjustments to various settings, then making corresponding adjustments to equipment before running test samples.

When multiple solutions for adjusting the spectrometer are available, one may be preferable to the other because certain adjustments may result in unintended consequences, for example, the Orifice 1 Voltage can cause fragmentation when the voltage is too high. This risk may not show up as fragmentation on chemical standards as opposed to a more complex system or matrix, that is, serum. A person skilled in the art would know what range of voltage settings would be acceptable for a particular analyte. It is contemplated that the instrument's operator also could tune the machine to particular fragmentation patterns, or a standard pattern reflecting a certain extent of fragmentation.

Also, a person skilled in the art may wish to evaluate the plots of relative ratios of one or more peaks of reference sample molecules as a given pattern of relative ratios may suggest a particular adjustment to one or more adjustment parameters. For example, an instrument manufacturer might wish to go through a series of such single parameter change profiles to try to characterize the types of ratio changes each setting produces and use the relative ratio plots to guide the instrument operator to the most likely parameter to adjust. Alternatively, an instrument operator may wish to develop the same kind of characterization profile for a given instrument. The centroiding approach described in this application will provide more precise adjustments. In addition, a person skilled in the art can utilize two distinct sets of reference samples, using the first set to tune the instrument, for example, on two different days (or on two different machines from the same manufacturer or two entirely different platforms) and then to use the second set of compounds to confirm/validate that the instrument readings are in the same or substantially the same Euclidean space for the entire spectral range of interest.

### EXAMPLES

The following examples are provided to describe and illustrate the present invention. As such, they should not be construed to limit the scope of the invention. Those skilled in the art will well appreciate that many other embodiments also fall within the scope of the invention, as it is described hereinabove and in the claims.

The following examples 1 through 5 reflect experimental work conducted by the inventors using an AccuTOF mass spectrometer and adjusting the following equipment settings and parameters: Needle Height, Peaks Voltage and Orifice 1 Voltage. Also, data from two AccuTOF mass spectrometers is presented in Example 7.

### Example 1

### Needle Position Adjustments

The height of the needle in an AccuTOF mass spectrometer was changed in step-wise manner by turning the needle height knob. As shown in FIG. 1, different positions of the needle resulted in changes in the height (intensity) of various peaks found at the indicated m/z values. In performing this experiment, NO-0 is a setting as low as the needle can go, NO-3 is 3 complete turns of the adjustment, NO-6 is 6 complete turns up from NO-0, NO-9 is 9 complete turns up from NO-0 and NO-12 is 12 complete turns up from NO-0—position. Three analyses of sample were made at each needle position; two repeat analyses were made at each of positions NO-0 and NO-12. We believe that analyses 16 and 17 (at setting NO-0) may have been set improperly or may reflect a time delay artifact. It was determined that the setting NO-12 might be the most internally reproducible setting for the needle height and also note that by adjusting the needle height, the signal intensity can be adjusted.

### Example 2

### Peaks Voltage Setting

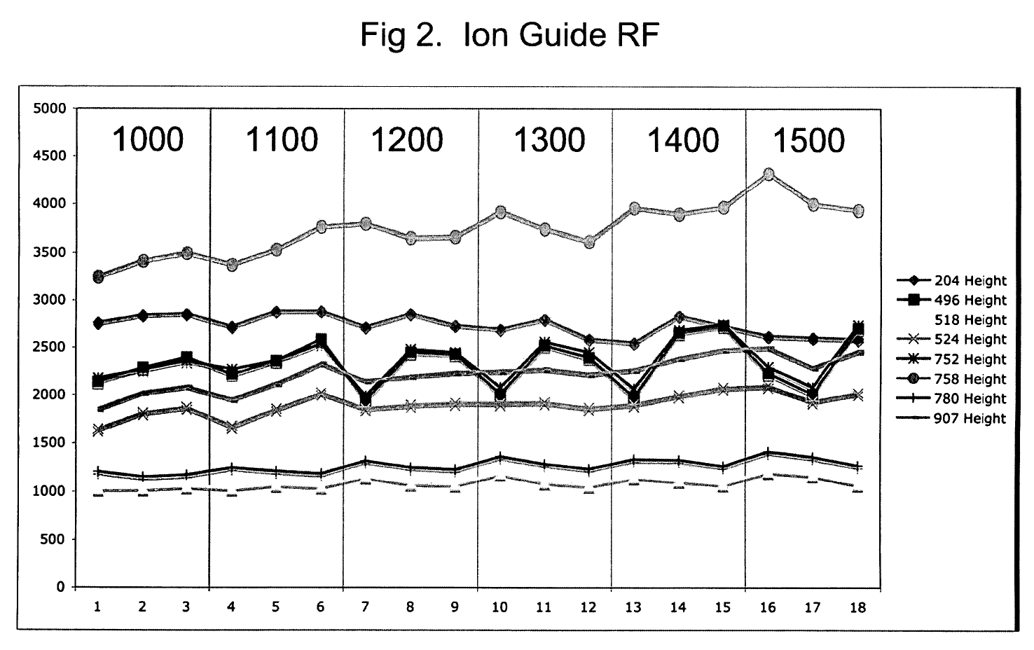

The RF Guide Voltage of the AccuTOF was adjusted in a stepwise manner at 100-volt increments through the range of 1,000 volts to 1,500 voltages. As shown in FIG. 2, for all analyses, the peak height, i.e., intensity remained fairly constant except for a possible periodicity seen for m/z values of 752 and 496. Decreasing Peaks voltage may have the effect of decreasing intensity somewhat for some m/z values.

### Example 3

### Orifice 1 Voltage Adjustments

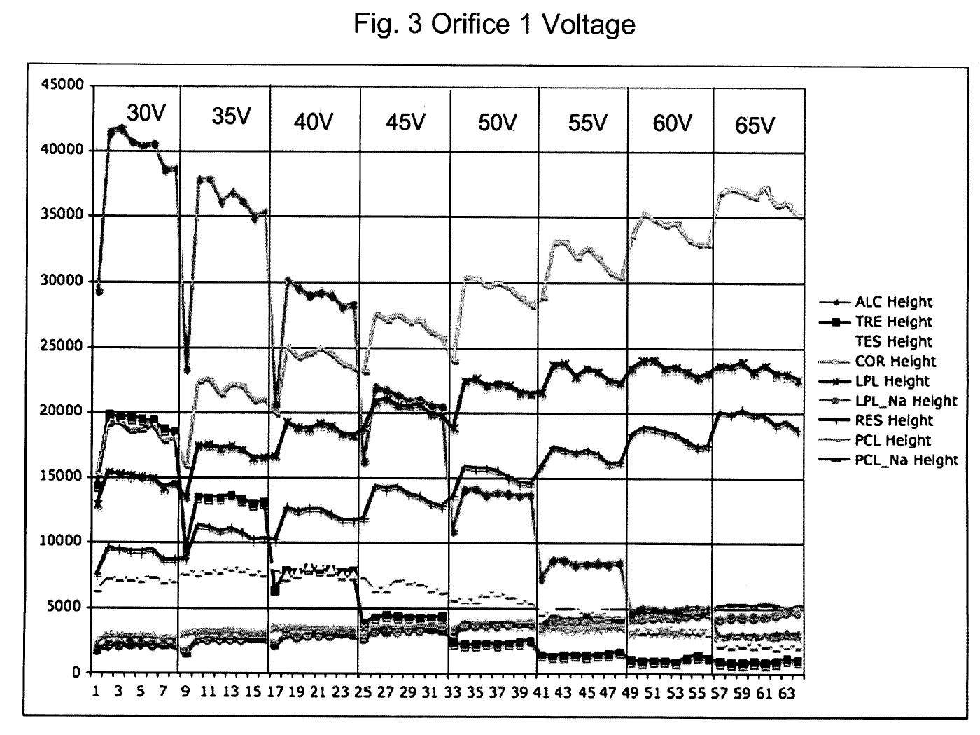

The Orifice 1 Voltage of the AccuTOF was adjusted in a stepwise manner at 5-volt increments through the range of 30 to 65 volts. This plot represents a spray sequence of a standard mixture of compounds. As shown in FIG. 3, intensity for some peaks tended to increase across this voltage range, to decrease for others and to hold fairly constant for some test compounds.

### Example 4

### Analysis of the Voltage Series Centroid Plot

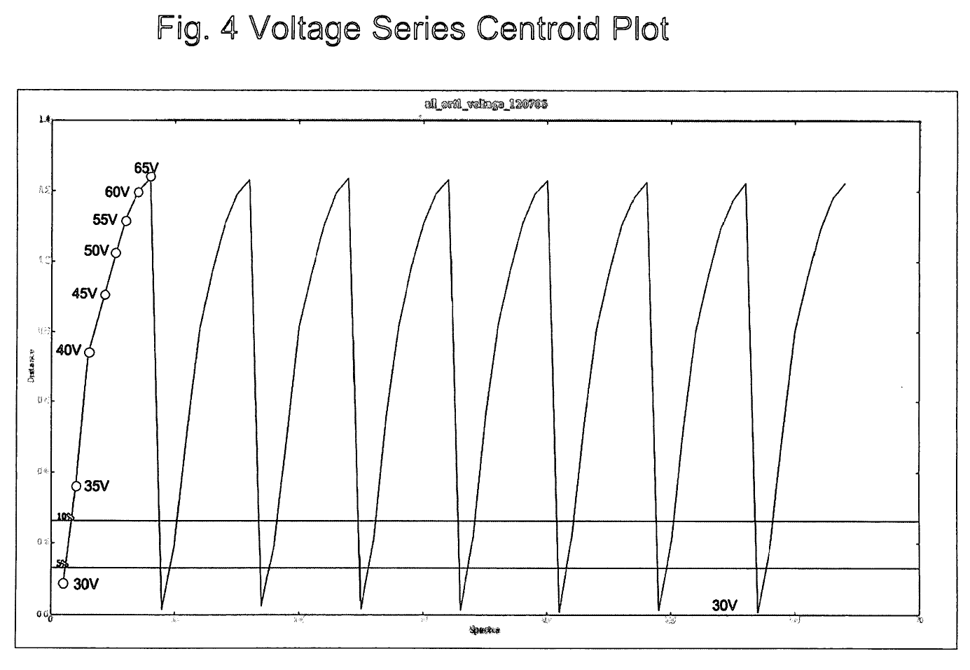

The data presented in FIG. 3 was plotted in FIG. 4 to show variability in the centroid computed for the sample mixture at various Orifice 1 Voltage settings as described in Example 3. The voltage setting ranged from 30 volts to 65 volts with 5-volt increments. Eight voltage series are shown, each being comprised of spectra derived from the reference mixture of eight compounds, for a total of 64 spectra. The features in the standard mixture were used to build a reference centroid using all of the 30-volt spectra to which all the spectra were compared. This plot shows the distance of the test centroids from the reference centroid. It is clear from the plotted data that the movement of the computed centroid varied regularly over the voltage adjustment cycle and that upon reaching the 65 volt setting, dropping the voltage back to 30 volts reduced the centroid-to-centroid distance so that the 30 volt settings were substantially at the same location in n-dimensional space.

### Example 5

### Comparison of Two Spectrometers TOF Voltage Adjustments

FIG. 5 shows the variation in intensity of signals from two AccuTOF spectrometers, for which the Orifice 1 voltage settings were varied as described in Examples 3 and 4 over the range of 30 volts to 65 volts. By adjusting the Orifice 1 voltage of TOF 1, the intensity and intensity ratios were brought more reproducibly in line with the intensity results for TOF 2.

### Example 6

### Calibration of a Micro-Array Scanner

By analogy, the foregoing methods as described for a mass spectrometer can be applied to any type of detector or measurement where you have some type of feature and an associated measurement. Instrument settings for a micro-array detector are described, for example, in the User Manual for the GeneTAC LS IV Microarray Scanner (2002). Such settings include pixel number, scan speed, and laser and filter adjustments. A reference centroid for the hybridization intensity of selected genes for a given sample is computed as described above for the analogous intensity of signal for a given m/z value on a mass spectrometer. A test centroid is determined at another time or with another scanner in an analogous manner. The distance between centroids is determined and adjustments are made to the scanner's settings as appropriate in order to decrease the centroid-to-centroid distance. A person skilled in the art will be able to determine which setting(s) are most likely to decrease this distance and exercise routine judgment as to which settings are appropriate for a given sample.

### Example 7

### Evaluation of Thermometer Ions

Two thermometer ion (THI) compounds were utilized to evaluate two AccuTOF instruments. The experiments were performed in parallel using the same solutions, THI p-chlorobenzyl or p-methoxybenzyl (p-Cl or p-OCH₃) pyridinium chloride: 200 μl in each well at a concentration of 0.2 μM in mobile phase plus 5 mM ammonium formate (MP+AF 5 mM). Samples were injected by row and column 1 contained blanks. The p-Cl data was more reproducible so it was used in the following analyses. Ratios of precursor (P) and fragment (F) peaks were used to evaluate the instrument characteristics.

The following instrument parameters were evaluated: RF (Peaks Voltage in a 500-1500 volt range range), RL (Ring Lens voltage in a 2-22 volt range), DV (Detector Voltage in a 2100-2600 volt range); and ORI1 (Orifice 1 Voltage in a 20-60 volt range.) Two replicates of the data were acquired to evaluate intra-day reproducibility and two days of data (Aug. 17, 2007 and Aug. 30, 2007) were collected to evaluate inter-day reproducibility. It was found that thermometer ion-based characterization of the instruments was sufficiently sensitive and reproducible (based on the evaluation of two instruments within a single day) to provide a useful means of characterizing differences between instruments and for a single instrument overtime according to the methods of the present invention.

As an alternative and complimentary strategy to evaluating Euclidean distances between centroids, normalized ratios of precursor and fragments ions may be plotted (in a spreadsheet) versus a given instrument voltage and the distance between specified points on the resulting curve obtained at different times on one instrument or from two different instruments may be used to assess the similarity or difference in the instrument calibration. A suitable formula for calculating such a curve for changing the orifice 1 voltage on an AccuTOF is given below:

$$S = \frac{{I}_{p}}{( {I}_{p} + {\sum }_{1}^{i} {I}_{{f}_{i}} )}$$

Where,
S is the survival function value
Iₚ is the mean intensity of the precursor molecular ion
I_{fi} is the mean intensity of any related fragment ion

### Example 8

### Centroid Analysis for the Optimization of Spectrometer Performance

A parallel four-day study was conducted using the JEOL AccuTOF (JL) and the Agilent LC-TOF (AG). Human serum samples were utilized, and 192 samples/day (2 plates) for four consecutive days were analyzed by flow injection. Each day, 80 sample sera (40 male and 40 female) were processed in duplicate along with 16 “standard” sera (as defined below) and 16 blanks. The reproducibility of the instruments' performance was evaluated by monitoring a mixture of five selected compounds, spiked in “standard serum”, that is, a pool made by combining 5 male and 5 female individual sera. For each day of analysis, aliquots of the standard serum were spiked with a mixture made of the following compounds: (1) AMI=9-Amino Acridine 12.5 nM having expected m/z195.091; (2) ALC=Acetyl Carnitine 50 nM having expected m/z 204.123; (3) PC11=Phosphatidyl choline (C11-C11) 50 nM having expected (m/z 594.412); (4) RES=Reserpine 50 nM having expected m/z 609.281 and (5) PC12=Phosphatidyl choline (C12-C12) 50 nM having expected m/z 622.444. The blanks contained mobile phase only. The first eight spiked serum samples were used to build the reference centroid. From the analysis of additional spiked serum samples, feedback on the stability of the analytical procedures was obtained by measuring the Euclidean distance between the reference centroid derived from the first eight spiked serum samples and the test centroid obtained from the remaining spiked serum samples.

After the second day, the electrospray needle was removed and replaced. The instrument was re-tuned in a way that the MS performance and the relative intensities of the peaks of the standard compounds were as close as possible to those of day 1. After replacing the needle, the instrument was returned by changing the following parameters: needle position, selected ion source voltages (Orifice 1, Needle Voltage) and the voltages were adjusted while looking at the profile of the standard mixture (i.e., the five standard compounds). The manual reproducibility-targeted returning took approximately three hours. The first step was a conventional one-compound tuning of the MS performance on one peak of the standard mix (reserpine), then the needle height and the indicated voltage parameters were changed based on the visual inspection of the outcome of approximately 20 individual injections. After selecting the parameters that gave the closest Euclidean distance between a centroid obtained from spiked standards and the reference centroid, the remaining samples were analyzed.

The overall reproducibility of the four-day study was acceptable for the experiment conducted (that is, the Euclidean distance of the test centroid from a reference centroid created on standards acquired on “Day 1” was generally within about 5% throughout the entire four days of the study).

### Examples of Multiple Parameter Tuning

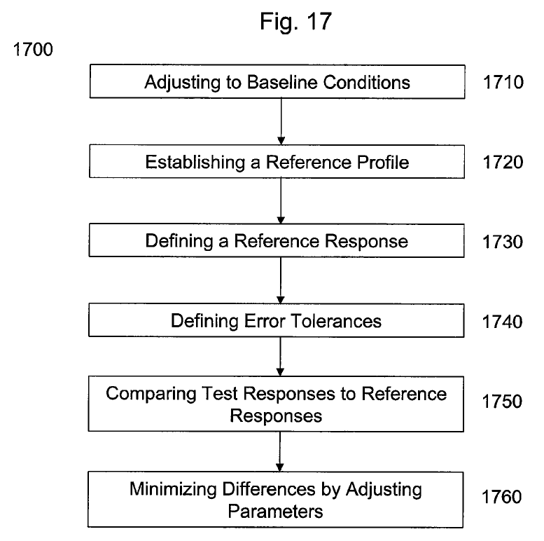

In some embodiments, multiple parameters on an instrument, such as an analytical instrument, can be adjusted to tune the instrument to a desired condition. For example, in one embodiment of the invention multiple parameters are adjusted on an instrument to cause the instrument to have a response similar to the response of the instrument at some earlier time. In another embodiment, multiple parameters on an instrument are adjusted to cause the instrument to have a response similar to that of another instrument. FIG. 17 is a flow chart of a method of tuning an instrument based on variations of multiple reference parameters of the instrument, according to an embodiment of the invention. Method 1700 includes adjusting the instrument to baseline conditions 1710, establishing reference profiles of compounds using the instrument 1720, defining a reference response of the instrument 1730, defining error tolerances 1740, comparing a test response to the reference response 1750, and minimizing differences by determining an adjustment to the parameters based on the reference profiles, reference response, test response and/or test profiles 1760. In some embodiments, an output of data associated with any of these steps and/or adjustment information can be produced and, optionally, displayed or outputted for an instrument operator or user.

Adjust to Preferred Operating Conditions

Adjusting an instrument to the preferred operating conditions as recommended by the manufacture or determined by the operator can help to improve reproducibility and ensure the best performance of the instrument. An instrument can be adjusted to these conditions by, for example, using a manufacturer's standard procedures for achieving the established optimal resolution and sensitivity (and mass accuracy with respect to a mass spectrometer). Appropriate procedures to establish preferred operating conditions can include, for example, using standard compounds to calibrate the instrument, adjusting various settings to appropriate levels for intended use, completing a startup or initialization procedure for the instrument, and/or ensuring that (1) the instrument is in a stable operating condition, (2) any hardware or software interacting with the instrument is appropriately configured and adjusted, and (3) the instrument is in a condition that can be replicated. In certain embodiments of the present invention associated with some instruments, the baseline conditions will be those similar to the conditions under which the instrument will be used. For example, when analyzing blood samples with a mass spectrometer, it can be advantageous to run a number of preliminary samples or make measurements after cleaning or servicing the mass spectrometer in order to create the conditions within the mass spectrometer that are typical of a mass spectrometer in use. It is contemplated that an optimized initial setting for the instrument may also include the step of establishing that the instrument reproducibly measures a known fixed ratio such as a reference compound's isotopic ratio.

Establish a Reference Profile

A reference profile of an instrument characterizes the response of an instrument to a selected analyte under various conditions and settings that are adjusted for multiple parameters. The profile can include, for example, graphs or charts of instrument responses, tables of instrument responses and/or matrices of instrument responses. For example, a reference profile of a compound for a mass spectrometer can include a graph of m/z relative peak intensity ratios of the compound observed under a range of voltage settings at various locations and components within the mass spectrometer. In some embodiments, the voltage settings can be absolute settings. In other embodiments, the voltage settings can be relative and adjusted to maintain a constant relationship between some parameters while changing the relationship between others. In some embodiments, parameters other than voltage settings can be varied to create a reference profile for the instrument using a particular molecule or compound.

A reference profile can be created by introducing an analyte (a compound) or a number of analytes (or compounds) into an instrument and recording the instrument responses to various operating conditions of the instrument including, for example, a range of settings of instrument parameters, such as voltages applied to a particular component, or environment conditions such as, for example, ambient temperature. In some embodiments, instrument responses can be recorded and indexed by the parameter values or settings that resulted in each instrument response. In other embodiments, multiple reference analytes are used to create a reference profile of an instrument. Thus, in some embodiments, the reference profile of an instrument can be a composite reference profile including a series of profiles where each represents an individual reference analyte. For example, because a mass spectrometer can differentiate between multiple thermometer ions used as reference analytes, a reference profile for a mass spectrometer can be a composite reference profile including a reference profile for each thermometer ion used as a reference analyte.

In some embodiments, reference profiles can be interpreted by a processor such as, for example, a personal computer or an embedded processor as part of an instrument or a separate data processing unit coupled to the instrument. Some embodiments include a processor, a related processor-readable medium having instructions or computer code thereon for performing various processor-implemented operations and/or a display monitor. Such processors can be implemented as hardware modules such as embedded microprocessors, microprocessors as part of a computer system, Application-Specific Integrated Circuits (“ASICs”), and Programmable Logic Devices (“PLDs”). Additionally, such processors can also be implemented as one or more software modules in programming languages as Java, C++, C, assembly, a hardware description language, or any other suitable programming language. A processor according to some embodiments includes media and computer code (also can be referred to as code) specially designed and constructed for the specific purpose or purposes. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floptical disks, and read-only memory (“ROM”) and random-access memory (“RAM”) devices. Examples of computer code include, but are not limited to, micro-code or micro-instructions, machine instructions, such as produced by a compiler, and files containing higher-level instructions that are executed by a computer using an interpreter. For example, an embodiment of the invention may be implemented using Java, C++, or other object-oriented programming language and development tools. Additional examples of computer code include, but are not limited to, control signals, encrypted code, and compressed code.

In some embodiments, the reference profiles and/or other data are output to a user using, for example, a display device or monitor or printer. Examples of display devices and monitors include computer monitors such as CRT or LCD displays, LED displays or arrays, and/or television monitors. Other examples of display monitors include displays embedded in an instrument and remote terminals such as a client accessing a remote server application.

The analytes used to create a reference profile of an instrument can be referred to as reference analytes (or compounds). In some embodiments, a reference analyte is chosen for a specific instrument based on desirable properties of the analyte or the response of the instrument to the particular analyte. For example, compounds having multiple m/z relative ratio peaks when analyzed by a mass spectrometer can be used as analytes for producing a reference profile of a particular analyte for a mass spectrometer, for example, cytochrome c. In some embodiments, thermometer ions can be desirable for use as reference analytes for producing a reference profile of a mass spectrometer due to the way in which thermometer ions interact with the ion optics of a mass spectrometer and the fragmentation properties of thermometer ions.

Multiple parameter tuning in particular benefits from the use of thermometer ions, as described herein, which fracture or break apart under different instrument conditions. Various internal energy levels are induced in thermometer ions as thermometer ions pass through the ion optics of a mass spectrometer by changes in voltages in and pressure around the ion optics. The result is that different thermometer ions fracture or break into multiple components at different areas and energies in the mass spectrometer. This allows probing of various portions of the mass spectrometer. Additionally, thermometer ions can be observed or measured in a mass spectrometer as a ratio of the pre-fracture part (precursor) and the post-fracture parts (fragment). This property of thermometer ions can be particularly advantageous and less subject to variation or drift in measurement because thermometer ions can be measured as ratios to themselves rather than to some other substance.

Similar to the selection of a particular analyte or class of analytes, in some embodiments, particular parameters of an instrument can be selected to be varied during analysis based on desirable results in the response of the instrument to variation in the parameters. Determining which particular parameters produce desirable results can be particularly advantageous, for example, when an instrument has many parameters that can be varied, because a small number of parameters to be varied can result in more timely tuning. Parameters that are chosen to be varied to create a reference profile can be referred to as reference parameters. In some embodiments, for example, it can be desirable that variation in reference parameters has a significant impact on the instrument response to reference analytes. In other embodiments, it can be desirable that variation in a particular reference parameter has a significant impact on the instrument response to a single reference analyte. In yet other embodiments, it can be desirable that variation in reference parameters has little impact on the instrument response to reference analytes. The desirability of any particular effect can be related to the range of tuning and/or sensitivity desired for a particular instrument and can vary between embodiments. For example, a reference parameter having a significant impact on the instrument response to a reference analyte can be desirable to allow a relatively broad range of tuning of the instrument by variation of that particular reference parameter. Conversely, for example, a reference parameter having an insignificant impact on the instrument response to a reference analyte can be desirable to allow a relatively narrow or fine range of tuning of the instrument by variation of that particular reference parameter.

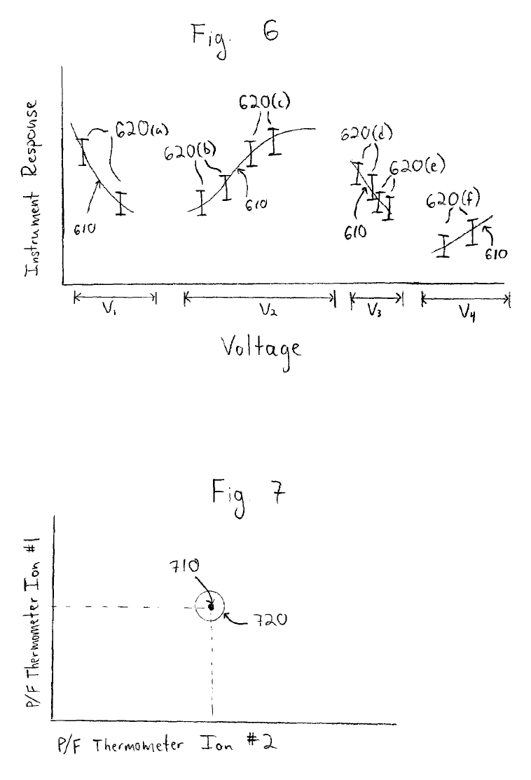

The reference profile in FIG. 6, for example, was created by varying voltage parameters V₁, V₂, V₃ and V₄ on an instrument through a relatively broad portion of the acceptable range for each parameter and recording instrument response 610. V₁, V₂, V₃ and V₄ represent voltages at different portions or locations of a mass spectrometer. Each of V₁, V₂, V₃ and V₄ was adjusted over a predetermined range while the remaining V₁, V₂, V₃ and V₄ were held constant. For example, while V₁ was varied over its predetermined range (illustrated by the double-arrow line in FIG. 6 labeled V₁), V₂, V₃ and V₄ were held each at a constant voltage. Thus, reference profile 610 was created sequentially. This process defines an instrument's response over different settings that cumulatively define the tuning space for the selected compound(s) as they are analyzed by that instrument.

Select a Reference Response

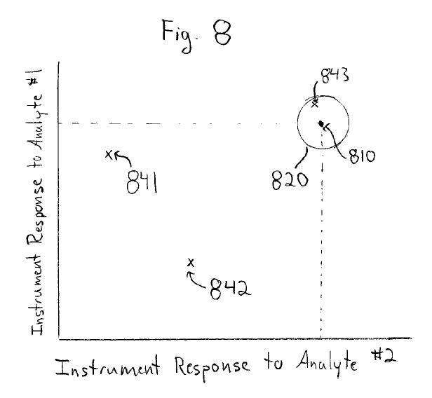

A reference response is a preferred pattern of relative ion intensities as represented, for example, by the centroid shown in FIG. 7. The term “response” refers to the response of an instrument to a given analyte under defined conditions at particular instrument settings. By way of example, a reference response would be chosen for a particular analyte(s) that corresponds to specific voltage settings selected along the ranges for V₁, V₂, V₃ and V₄ as shown in FIG. 6. The reference response will be used as the target for tuning the same or other instruments to achieve substantially similar performance and results for a given analyte. Persons skilled in the art will recognize that the selection of appropriate instrument settings will differ according to the purpose and application that is contemplated. For example, when a mass spectrometer is utilized, it must be determined whether or not or the extent to which analyte fragmentation is desired as this will be affected by the voltage settings on various instrument components that are described by the reference profile. Appropriate selection of analytes and evaluation of instrument response is required. Thus, the reference response will be selected from one or more places in the tuning space determined by the reference profile. According to the present invention, instrument settings are selected by the operator (or instrument itself) that adjust parameters to produce the desired response of the instrument. A reference response can be created and used as a standard for measuring variation with later instrument responses or responses of other instruments. A reference response of an instrument can be created before or after creating a reference profile by recording the response of the instrument to reference analytes when the instrument is in a preferred, nominal, or beginning condition. In some embodiments, these conditions can be default or starting conditions that will be used in later analysis using the instrument or on other instruments. In other embodiments, a reference response is created after a reference profile has been created. In such embodiments, it can be advantageous to set the instrument to preferred operating conditions as previously discussed. In some embodiments, adjustment of certain instrument parameters according to the manufacturer's specifications or according to the operator's experience may be sufficient to place the instrument in a preferred or nominal condition.

FIG. 7 is a reference response of an instrument, according to an embodiment of the invention. More specifically, FIG. 7 is a reference response or centroid of a mass spectrometer using two thermometer ions as reference analytes. In some embodiments, the number of reference analytes is the same as the number of reference parameters. Such embodiments can be particularly advantageous when certain analytes are especially sensitive to adjustments of specific reference parameters. In other embodiments, the number of reference analytes is greater than the number of reference parameters. In yet other embodiments, the number of reference parameters is greater than the number of reference analytes. As shown in FIG. 7, reference response 710 is a centroid positioned on a two-dimensional plane or graph as a function of the instrument response to two thermometer ions (indicated by relative precursor/fragment or P/F peak ratios). Thus, reference response 710 is a two-dimensional centroid. The circle 720 drawn around centroid 710 indicates tolerance. The number of dimensions in the reference response or centroid is based on the number of reference analytes. Generally, the number of dimensions in the reference centroid is equal to the number of reference analytes. In some embodiments, it may be convenient to visualize higher dimensions by plotting ratios of ratios on each axis in two dimensions, for example, (P₁/F₁)/(P₂/F₂) vs. (P₃/F₃)/(P₄/F₄). Absolute measurements, such as signal intensities, or other data also may be used instead of ratios.

Define Error Tolerances

In some embodiments, it can be advantageous to determine error ranges in the reference profile or the reference response. For example, instrument responses can vary within acceptable ranges over time or between instruments. Error ranges can differ for different instruments and different requirements of analysis being performed with the instrument and this information can be used to set an acceptable tolerance for the reference response. Thus, error tolerances in a particular embodiment can be defined by numerous methods including, for example, defining the error tolerances from manufacturer-specified operating tolerances of an instrument, theoretically calculating the tolerance needed for a particular use of an instrument and/or empirically determining a mean reference profile and a mean reference response over time. Mean reference profiles and reference responses can be empirically determined over time by creating reference profiles and reference responses with an instrument over, for example, a number of days or experiments and calculating a mean reference profile and a mean reference response based on each day's reference profile and reference response, respectively. In some embodiments, a mean reference profile and mean reference response can be calculated for a number of instruments by, for example, creating reference profiles and reference responses with a number of different instruments and calculating a mean reference profile and a mean reference response based on each instrument's reference profile and reference response, respectively. In yet other embodiments, combinations of the above methods can be used to achieve the tolerance desired for the particular embodiment. FIG. 6 illustrates error bars 620 indicating error tolerances for the reference profile. FIG. 7 illustrates the tolerance 720 for the reference response.

Compare Test Responses to Reference Responses

As discussed above, embodiments of the invention can be used to ensure that an instrument provides similar responses to a particular analyte or compound over time by, for example, determining adjustments to instrument parameters to tune the instrument to some preferred, nominal or original operating condition. In some embodiments, reference analytes discussed above in relation to creating a reference profile and reference response are used together with the reference profile and reference response of an instrument to tune an instrument during use or testing of the instrument. In some embodiments, instrument response to a reference analyte is measured periodically during use to monitor variation in the instrument response to the reference analyte. These instrument responses can be referred to as test responses. For example, the instrument response to the reference analyte may be measured every hour, every day, or every week. Instrument response also may be measured continuously by using a dual sprayer strategy or an interleaved analysis strategy like that implemented on some spectrometer instruments sold commercially by Waters Corporation, for example with its multiplexed electrospray ion source (that is, the MUX-Technology™ system of Waters). The same sprayer would need to be used consistently for the reference profile and the selected reference response. In some embodiments, the test response can be a centroid as discussed in relation to creating the reference response.

In some embodiments, a test response can be measured or created by measuring or observing the instrument response to a reference analyte separate from the operational measurements of the instrument. For example, between blood samples being analyzed with a mass spectrometer, reference analytes can be analyzed with the instrument to measure the test response. In other embodiments, the instrument response to a reference analyte can be measured together with the operational measurements of the instrument. Thermometer ions, for example, can be advantageous because of their reaction properties in a mass spectrometer as discussed above.

In some embodiments, thermometer ions used as reference analytes can be added to a serum (sometimes referred to as spiking the serum) that is analyzed by a mass spectrometer without affecting the m/z relative peak ratios of the components of the serum as measured by the mass spectrometer. Thus, the mass spectrometer response to the thermometer ions can be measured simultaneous with measurements of the serum. In such embodiments, the instrument response to the reference analyte can be measured with each use of the instrument, which can be advantageous, for example, when frequent tuning is necessary. Additionally, multiple reference analytes can be used to determine a test response as discussed above in relation to creating a reference response. Furthermore, although thermometer ions have been discussed as being particularly advantageous, other compounds or analytes may be used as reference analytes. Other thermometer ions that can be used include quinolinium or acridinium salts. For example, another useful thermometer ion is (4-methoxybenzyl) 7-chloro-4-iodo-quinolinium iodide. Other compounds that may be useful include oligonucleotides, glycosides, and carbohydrates (basic molecules for positive mode operations of a spectrometer and acidic molecules for negative mode operations). Although the examples in this specification that relate to mass spectrometers exemplify positive ion analysis, the principles and methods of the present invention are also relevant to negative ion analysis with negatively charged reference compounds. Various other molecules that contain, for example, a nitrogen component that forms part of an aromatic ring and can be substituted with a moiety that will generate a very stable positive ion can be utilized. Also, evaluations of the relevant fragmentation products of a candidate thermometer ion and evaluations of the location of corresponding peaks along the m/z range of interest if calibration or tuning of a mass spectrometer is desired can be made.

Test responses can be compared to the reference response to determine whether an instrument requires tuning. After a test response is measured, it can be compared with the reference response. If the test response is sufficiently similar to the reference response, tuning is unnecessary. However, if the test response differs from the reference response by more than a critical amount, tuning is necessary. In some embodiments, the error tolerances discussed above can be used to determine whether a test response indicates that tuning is necessary. The test response can be compared to the reference response using a wide variety of methods including, for example, using a distance between the test response and reference response, measuring the angle between vectors, or computing dot products between vectors. In some embodiments using a reference centroid, multidimensional methods using the foregoing techniques can be used to compare the distance between a test response and a reference response.

FIG. 8 illustrates a reference response 810, an error tolerance 820, and test responses 841, 842 and 843, according to an embodiment of the invention. Test responses 841 and 842 are not within error range 820 and, thus, not acceptable. Accordingly, some tuning is likely necessary. Test response 843 is within error tolerance 820 and, as such, is sufficiently close to reference response 810 to indicate that the instrument that produced test response 843 does not require tuning.

Minimize Differences in Instrument Responses by Adjusting Instrument Parameters

If comparing a test response and a reference response indicates that tuning is necessary, a profile of the instrument under the current operating or testing conditions can be created for the tuning process. This profile can be referred to as a test profile and can be created using the methods discussed above in relation to creating a reference profile. It is unnecessary to adjust the instrument to baseline conditions prior to creating a test profile because a test profile is created under the operational or testing conditions of the instrument. A test profile can be used to determine which reference parameters of the instrument can be adjusted to tune the instrument to a preferred operating condition. Furthermore, a test profile can indicate whether general adjustments, cleaning, or manufacturer calibration can improve the operation of the instrument. Thus, a test profile can be first used to determine whether tuning of reference parameters or some other action and/or calibration will result in a preferred or desirable operating condition.

Some variations between the test profile and the reference profile can indicate that manufacturer calibration is desirable or necessary. For example, on a mass spectrometer, a substantially constant offset from the reference profile to a majority of the data points in the test profile can indicate that manufacturer calibration is necessary. In some embodiments, for example a mass spectrometer with thermometer ions used as reference analytes, the reference profile and test profile can be represented in two-dimensional vector space with one axis representing precursor/fragment ratios and the other axis representing a particular parameter, for example, a voltage. In such embodiments, a substantially constant offset in a test profile from a reference profile would appear as a shift in the test profile from the reference profile.

FIG. 9 illustrates a vector space that includes a reference response 910 and a test response 920. Test response 920 is generally shifted relative to reference response 910 indicating that manufacturer calibration, cleaning, and/or some other service of the instrument may be necessary. In some embodiments, some variation in the test profile from the reference profile is acceptable. The amount of variation that is acceptable can be determined for a particular embodiment by the error tolerances as discussed above. If the variation in the test profile from the reference profile is greater than the error tolerances for the reference profile, the test profile can be compared to the reference profile to determine an appropriate adjustment to the instrument.

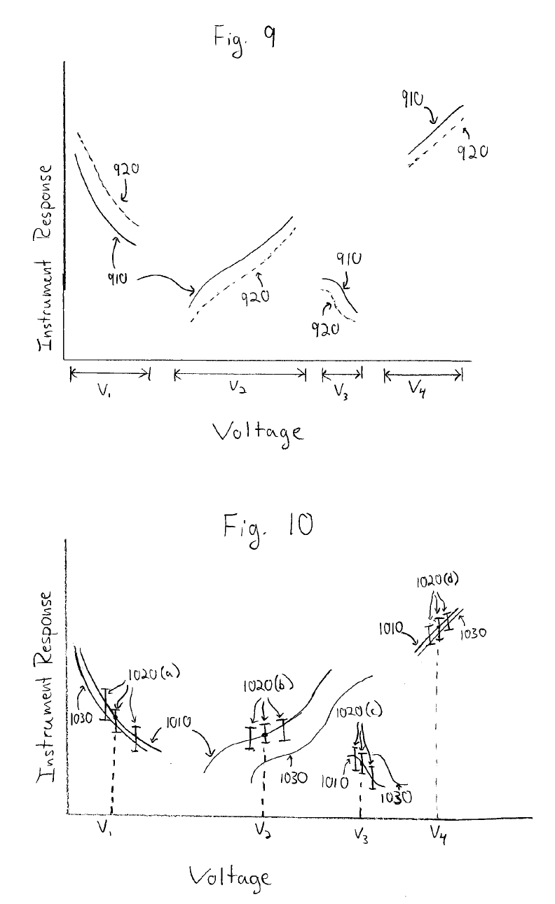

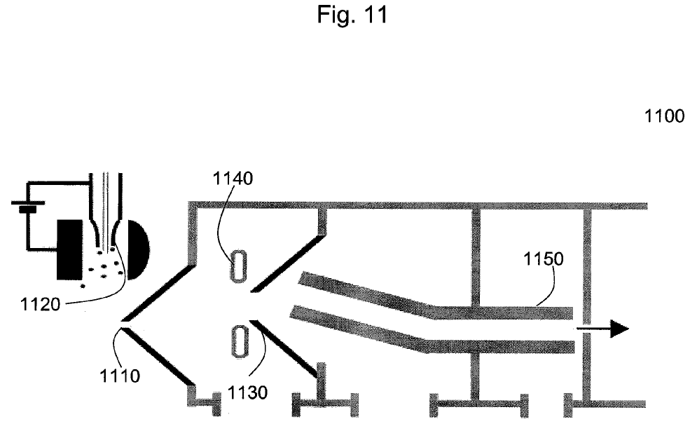

Variations between the test profile and reference profile may indicate that tuning the reference parameters of the instrument is appropriate. For example, on a mass spectrometer, such variation generally indicates that tuning reference parameters is appropriate. FIG. 10 illustrates a reference profile 1010 and a test profile 1030 according to an embodiment of the invention. FIG. 10 shows error bars 1020(a)-(d) indicating ranges of acceptable variations of instrument parameters about preferred, nominal, or beginning voltages V₁, V₂, V₃ and V₄, respectively. Test profile 1030 is generally shifted relative to reference profile 1010. This shift indicates that tuning is desirable because test profile 1030 is not within error bars 1020(b) or 1020(c).

If tuning is appropriate or necessary, the test profile and reference response can be used to determine adjustments to reference parameters that can tune the instrument to the preferred operating condition. Tuning can be accomplished by determining which combination of reference parameter variations can tune the instrument to the original or preferred operating condition (that is, determining a combination of reference parameter variations that tunes the instrument response to be as similar to the reference response as possible). In some embodiments, tuning is essentially an optimization problem with reference parameters as independent variables and instrument responses in the test profile as dependent variables. In some embodiments, the tuning or optimization problem can take the form:

P(p₁,p₂, . . . , p_{N})=Dist(Rₜ−Rᵣ)
where p₁, p₂, . . . , p_{N} are values of the reference parameters, Dist( . . . ) is a distance function, Rₜ is the test response, and Rᵣ is the reference response.

The tuning or optimization problem can be solved using various mathematical techniques. In some embodiments, the following method can be used. The P(p₁, p₂, . . . , p_{N}) can be coarsely mapped over the values of p₁, p₂, . . . , p_{N} included in the reference profile (for example, a sparse set of p₁, p₂, . . . , p_{N} covering the range of relevant values of p₁, p₂, . . . , p_{N}). The minima from P(p₁, p₂, . . . , p_{N}) are selected and a gradient-based method can be used to further refine or identify the minima. In some embodiments, the method can be a numerical method. A method of steepest decent, Marquardt-Levenberg, and/or conjugate gradient method, for example, can be used to refine or identify the minima. In some embodiments, more than one method can be used to better refine or identify (either in terms of efficiency or accuracy) the minima. Selection of the final minima p₁, p₂, . . . , p_{N} can be based on, for example, a final P(p₁, p₂, . . . , p_{N}) value, a rate of convergence, local topography of the optimization problem across the range of p₁, p₂, . . . , p_{N}(for example, a minimum approached by a low rate of decent can be preferable to a minimum approached by a high rate of decent because a small amount of instrument drift in the former will result in less variation than in the latter), and/or the position of the minima relative to the boundaries of the tuning space (that is, the range of values over which p₁, p₂, . . . , p_{N} can be varied).

The reference parameter modifications determined or identified by this process can be made to the reference parameters and the instrument response to the reference analyte or analytes can be measured to verify correct tuning. If the instrument response is acceptable as discussed above in relation to the test response, the instrument is tuned. In some cases, the tuning may have been unsuccessful as indicated by, for example, the instrument response differing from the reference response by more than the error tolerances. In such cases, a different minimum from the P(p₁, p₂, . . . , p_{N}) minima can be selected, the appropriate adjustments made to the reference parameters and the instrument response measured again. This process can be repeated until acceptable reference parameter values are determined or the minima of P(p₁, p₂, . . . , p_{N}) are exhausted. If the minima of P(p₁, p₂, . . . , p_{N}) are exhausted, the instrument can be cleaned, calibrated, and/or returned to the manufacturer for service. In some embodiments, the necessary adjustments to the reference parameters can be output to a display as discussed above. Specifically, the adjustments or values of the reference parameters can be output or displayed to a user on, for example, a computer screen. In other embodiments, a processor carrying out the method can effect the necessary adjustments to the reference parameters automatically, without the need for human intervention in adjusting instrument parameters. In a preferred embodiment, such automated approaches are integrated into the control software for a given instrument. Additionally, the tuning described above may optimally be repeated on a given instrument to improve reproducibility. Thus, whether implemented manually by the operator or automatically via control software or other system approaches, a recursive cycling through the tuning steps, perhaps three or four cycles, generally would be useful.

### Example of Creating a Reference Profile

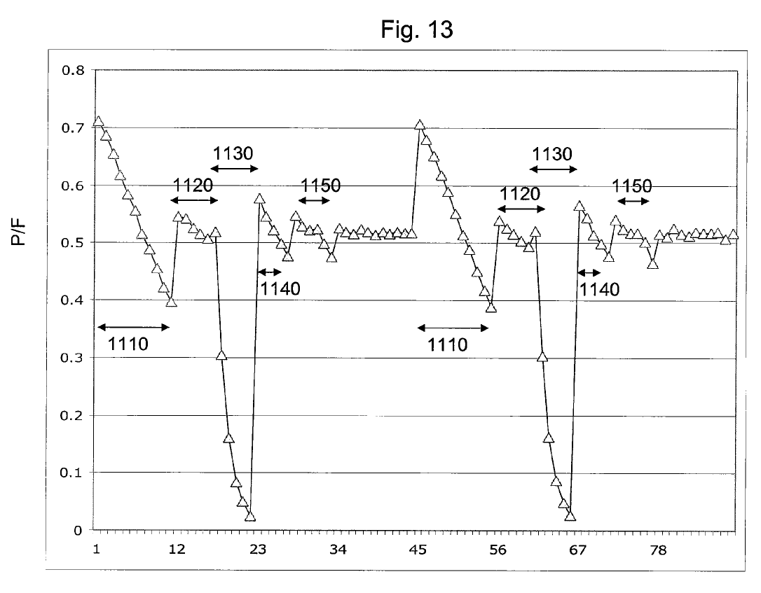

In one embodiment, a reference profile for a mass spectrometer is created. In this embodiment, the reference analytes are thermometer ions. FIGS. 11-17 show how a reference profile can be created for a mass spectrometer using thermometer ions. FIG. 11 is a schematic diagram of part of a first type of mass spectrometer including some adjustable parameters. The schematic diagram of the mass spectrometer shown in FIG. 11 has voltage parameters that are shown in FIGS. 13-17. Mass spectrometer 1100 has first orifice 1110, needle 1120, second orifice 1130, ring lens 1140, and quad RF ion guide 1150. Voltages can be applied to each of the items or location of mass spectrometer 1100. Specifically, first orifice 1110 has a voltage, needle 1120 has a voltage, second orifice 1130 has a voltage, ring lens 1140 has a voltage, and quad RF 1150 has a voltage. These voltages are adjustable parameters on mass spectrometer 1100.

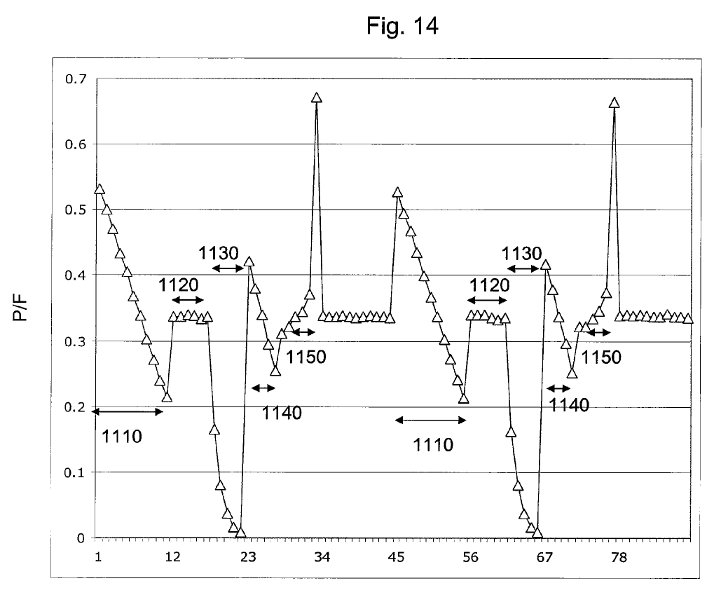

FIG. 13 shows the response of the mass spectrometer 1100 to a thermometer ion 4-chlorobenzyl pyridinium chloride (p-Cl) during variation of adjustable parameters of the mass spectrometer, according to an embodiment of the invention. FIG. 14 shows the response of the mass spectrometer to a thermometer ion 4-methoxybenzyl pyridinium chloride (p-OMe) during variation of adjustable parameters of the mass spectrometer, according to an embodiment of the invention. The double-arrow lines in FIGS. 13 and 14 indicate variations in the voltages applied to the elements of mass spectrometer 1100. The graphs illustrate variations in relative P/F ratios observed while varying the voltage applied to the labeled element over a predetermine range while holding the voltage settings applied to the other elements constant. Specifically, for example, the double-arrow line labeled 1110 indicates the portion of the graph impacted by variations in the voltage applied to first orifice 1110. FIGS. 13 and 14 indicate that variations in the voltages applied to first orifice 1110, second orifice 1130 and ring lens 1140 have more of an impact on relative peak ratios of the thermometer ions analyzed by mass spectrometer 1100 than do variation in the voltages applied to needle 1120 and quad RF 1150. Thus, first orifice 1110 voltage, second orifice 1130 voltage and ring lens 1140 voltage were chosen as the reference parameters for creating reference profiles of mass spectrometer 1100 for each thermometer ion. The amount of variation that is significant varies from instrument to instrument and between applications. Factors influencing whether a variation is significant include, the sensitivity of the instrument, amount of tuning expected and the sensitivity of the application. A larger variation can result in a broader tuning range, for example. Conversely, a small variation can result in a finer tuning range.

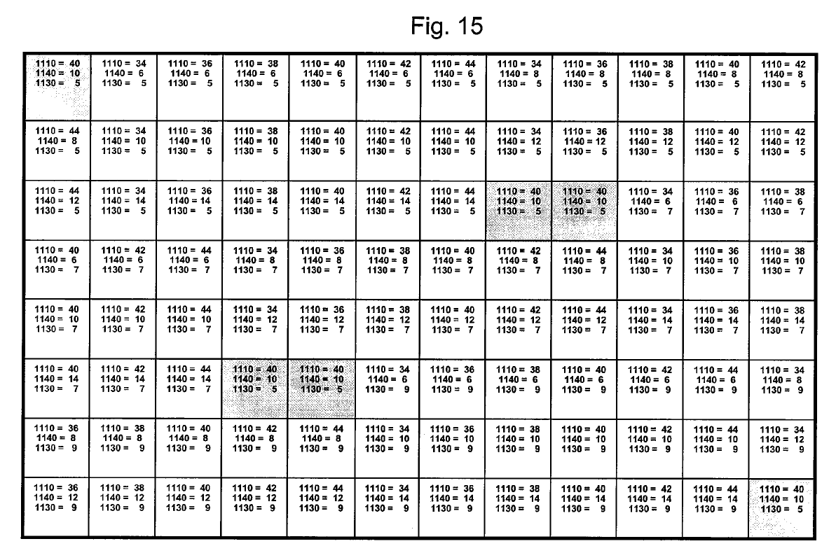

FIG. 15 shows a table of values for adjusting reference parameters of a mass spectrometer, according to an embodiment of the invention. The cells of the table in FIG. 15 include values of the voltages applied to reference parameters first orifice 1110, second orifice 1130 and ring lens 1140 for creating reference profiles for mass spectrometer 1100 for each thermometer ion. Specifically, this table shows that two voltages are fixed at values in their respective ranges of voltage settings, while the third is adjusted through its range of voltage settings. The process is repeated such that each voltage is adjusted through its range of settings for each setting in the ranges of settings of the other voltages.

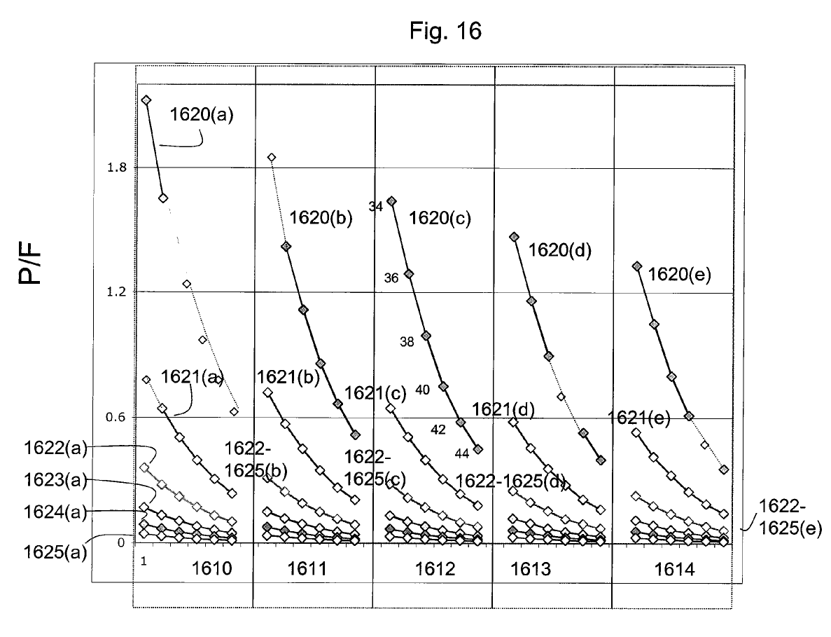

FIG. 16 shows a reference profile of a mass spectrometer, according to an embodiment of the invention. Specifically, FIG. 16 is a reference profile of p-Cl for mass spectrometer 1100. Horizontal regions 1610, 1611, 1612, 1613 and 1614 correspond to setting ring lens 1140 voltage to 6 volts, 8 volts, 10 volts, 12 volts and 14 volts, respectively. Curves 1620(a)-(e), 1621(a)-(e), 1622(a)-(e), 1623(a)-(e) and 1624(a)-(e) correspond to setting second orifice 1130 voltage to 5 volts, 7 volts, 9 volts, 11 volts and 13 volts, respectively. Diamond-shaped points on curves 1620(a)-(e), 1621(a)-(e), 1622(a)-(e), 1623(a)-(e), 1624(a)-(e) and 1625(a)-(e) correspond to various settings of first orifice 1110 voltage. Specifically, moving from left to right along each curve 1620(a)-(e), 1621(a)-(e), 1622(a)-(e), 1623(a)-(e), 1624(a)-(e) and 1625(a)-(e), the diamond-shaped points correspond to setting first orifice 1110 voltage to 34 volts, 36 volts, 38 volts, 40 volts, 42 volts and 44 volts. Curve 1620(c) shows each diamond-shaped point labeled with the corresponding setting of first orifice 1110 voltage.

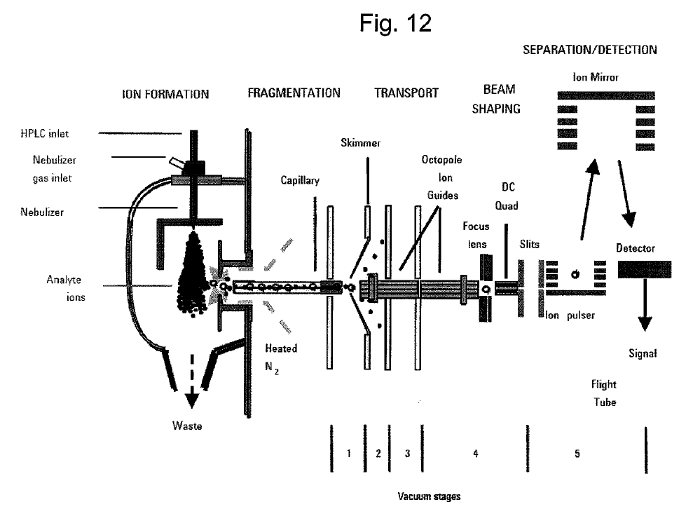

Similar methods can be carried out in connection with other instruments using the parameters and adjustments of such instruments. FIG. 12, for example, is a schematic diagram of another type of mass spectrometer, which can be calibrated or tuned according to this invention. Other instruments related to this invention include, for example, microarray scanners.

The embodiments and advantages of this invention are set forth, in part, in the preceding description and examples and, in part, will be apparent to persons skilled in the art from this description and examples and may be further realized from practicing the invention as disclosed herein. For example, the techniques of the present invention are readily applicable to cameras, pixel-detectors and array detectors. Additionally, it should be understood that the methods described herein can include various combinations and/or sub-combinations of the steps and/or features of the different embodiments described. For example, methods described with particular reference to a mass spectrometry may be applied to other instruments although not explicitly shown or discussed herein. Additionally, methods and associated steps discussed with reference to, for example, two dimensions can be accomplished in three or more dimensions. All documents identified in this patent application are hereby incorporated by reference in their entireties.

1. A method, comprising
providing a location in n-dimensional space of a reference centroid derived from a quantity of one or more compounds in a reference sample;
providing a location in n-dimensional space of a test centroid derived from a quantity of one or more compounds in a test sample processed by the instrument;
computing a vector associated with a distance between the reference centroid and the test centroid;
determining the extent to which an adjustment to one or more equipment settings would either decrease the distance between and/or improve the relative locations of the reference centroid and the test centroid; and
effecting an adjustment to the one or more equipment settings to calibrate the instrument.

2. The method of claim 1, wherein the instrument is a spectrometer

3. The method of claim 1, wherein the instrument is mass spectrometer.

4. The method of claim 1, wherein the instrument is selected from the group consisting of a microarray scanner, a protein chip reader and a nucleotide scanner.

5. The method of claim 1, wherein the one or more equipment settings includes a voltage setting.

6. The method of claim 1, wherein the effecting an adjustment is automated for the instrument.

7. The method of claim 1, wherein the one or more compounds in the reference sample are processed by the instrument.

8. The method of claim 1, wherein the reference sample is processed by the instrument.

9. A processor-readable medium, comprising program instructions configured to:
interpret a location in n-dimensional space of a reference centroid derived from a quantity of one or more compounds in a reference sample,
interpret a location in n-dimensional space of a test centroid derived from a quantity of one or more compounds in a test sample processed by an instrument,
compute a vector that reflects a distance between the reference centroid and the test centroid, and
output an appropriate adjustment to be effected on the instrument in order to decrease the distance between the reference centroid and the test centroid.

10. The computer readable medium of claim 9, further comprising:
program instructions configured to effect appropriate adjustment to the instrument.

11. The computer readable medium of claim 9, further comprising:
program instructions configured to display the distance between the reference centroid and the test centroid.

12. A method of tuning an analytical instrument, comprising:
locating a reference centroid in a vector space based on the results of passing a first compound and a second compound through a first analytical instrument;
locating a test centroid in the vector space based on the results of passing the first compound and the second compound through a second analytical instrument, the location of the test centroid in the vector space being a first location; and
providing an output to a user identifying a parameter of the second analytical instrument to be changed to move the test centroid to a second location in the vector space, the second location being closer to the location of the reference centroid than the first location.

13. The method of claim 12, wherein the first analytical instrument and the second analytical instrument are the same analytical instrument.

14. The method of claim 12, wherein the first analytical instrument is a mass spectrometer.

15. The method of claim 12, further comprising:
identifying the parameter based on a profile of the first compound, the profile of the first compound being produced by varying the parameter on the second analytical instrument.

16. The method of claim 12, wherein the parameter is a voltage at a location within a mass spectrometer.

17. The method of claim 12, wherein the first compound is a thermometer ion.

18. The method of claim 12, wherein the parameter to be changed moves the test centroid to an optimal location with respect to the reference centroid.

19. The method of claim 12, further comprising:
effectuating a change in the parameter of the second analytical instrument.

20. The method of claim 19, wherein the effectuating is automated.

21. The method of claim 12, wherein the method is implemented on a computer.

22. The method of claim 12, wherein the method is implemented on a computer readable medium.

23. The method of claim 12, wherein the output includes an identification of an amount of change that should be made to the parameter.

24. A method of determining a response profile of an analytical instrument having a first variable parameter and a second variable parameter, comprising:
passing a thermometer ion through the analytical instrument while the first variable parameter is set to a first value and the second variable parameter is set to a second value; the analytical instrument providing a first output useable by a user;
varying the first variable parameter and passing the thermometer ion through the analytical instrument; the analytical instrument providing a second output useable by a user; and
varying the second variable parameter and passing thermometer ion through the analytical instrument, the analytical instrument providing a third output useable by a user.

25. The method of claim 24, the varying the first parameter includes setting the first variable parameter to a third value and setting the second variable parameter to the second value.

26. The method of claim 24, wherein the first output useable by a user is a precursor-to-fragment ratio.

27. The method of claim 24, wherein the analytical instrument is a mass spectrometer and the first output useable by a user is a set of peaks, each peak being associated with either the thermometer ion or a fragment of the thermometer ion.

28. A method of selecting a reference response for an analytical instrument, comprising:
preparing a reference profile for a selected analyte by varying one or more instrument parameter over an appropriate range of settings to define a tuning space for that instrument; and
selecting a reference response that corresponds to instrument settings appropriate for the intended use of the instrument.

29. The method of claim 28, wherein the analytical instrument is selected from the group consisting of a mass spectrometer, an array scanner, a microarray scanner and a nuclear magnetic resonance instrument.

30. The method of claim 28, wherein the selected analyte is a thermometer ion.

31. A method of tuning an instrument, comprising:
adjusting instrument parameters so that the instrument response to the selected analyte substantially matches a selected reference response.

32. The method of claim 31, wherein the analytical instrument is a mass spectrometer.

33. The method of claim 31, wherein the selected analyte is selected from the group consisting of a mass spectrometer, an array scanner, a microarray scanner and nuclear magnetic resonance instrument.

34. The method of claim 31, wherein the tuning is automated.
